(19) United States
(12) Patent Application Publication
(10) Pub. No.: US 2009/0265884 A1
(43) Pub. Date: Oct. 29, 2009

(54) Sleeve and Component Provided Therefor

(76) Inventor: Freidrich Losberger, Abstatt (DE)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/887,634

(22) PCT Filed: Apr. 3, 2006
(86) PCT No.: PCT/EP2006/061265

§ 371 Date: Oct. 1, 2007

(30) Foreign Application Priority Data
Apr. 1, 2005 (DE) 20 2005 005 286.8

(51) Int. Cl. F16L 5/00

(52) U.S. Cl. 16/2.1

(57) ABSTRACT

The invention relates to a sleeve for introducing into an opening (3.3) which connects two sides (3.1, 3.2) of a component (3). Said sleeve consists of at least one cavity (1) which comprises a longitudinal axis (x) and which is connected to an external side (2). Said cavity (1) can be at applied at least to one part of the external side (2) at least in the radial direction in relation to the Said sleeve can be mounted in a simple and rapid manner and can be adapted in a precise manner to the structural tolerances. As a result, the sleeve is formed by at least two sleeve bodies (1.1, 1.2) which are arranged in a successive manner in the direction of the longitudinal axis (x). The first sleeve body (1.1) and the second sleeve body (1.2) can be connected together in the axial direction in relation to the longitudinal axis (x), by at least one connection element (4.1, 4.2) in a positive and/or non-positive fit.

### TECHNICAL FIELD

The invention relates to a sleeve to be placed in an opening which connects two sides of a component, which sleeve comprises at least one hollow body having a longitudinal axis and an external surface, it being possible to being at least part of the external surface of the hollow body to bear against the component at least in the radial direction relative to the longitudinal axis, and to a component provided with such a sleeve.

### PRIOR ART

A sleeve that is preferably introduced into an opening or bore connecting two sides of a component designed as a hollow section is well known in the prior art. Similar to the sleeve of the invention, the sleeve disclosed in the prior art also serves to protect the hollow section from damage to the wall of its opening and for preventing the hollow section from being squeezed when additional components are screwed on. The sleeve absorbs the mounting force introduced by means of a screw connection disposed inside the sleeve. The sleeve distributes the bearing pressure of a screw-threaded bolt of small diameter over a large surface. At the same time the sleeve serves as a spacer for the screw connection, so that particularly when hollow sections are used, they are not squeezed together.

The sleeve disclosed in the prior art has a protrusion beyond the hollow section, i.e. it is wider than the hollow section. After having been introduced into the hollow section, the press sleeve is flanged on its front face, giving rise to a collar, which secures the press sleeve on the hollow section in the axial direction. In the flanged state, the sleeve is always wider than the component, i.e. the collar projects. The flanging process is performed by means of a wobble riveting machine, which is generally operated stationarily on account of its size. The press sleeve abuts against the bore with no play in the radial direction. This is brought about preferably by providing the sleeve with a knurled surface, which simultaneously prevents the sleeve from rotating.

It is an object of the invention to design and arrange a sleeve of this generic type in such a way that it can be mounted more easily and rapidly and can be adapted more precisely to manufacturing tolerances.

### SUMMARY OF THE INVENTION

The object is achieved according to the invention by forming the sleeve as at least two sleeve bodies disposed in-line in the direction of the longitudinal axis, it being possible to connect the first sleeve body to the second sleeve body in the axial and radial directions relative to the longitudinal axis by means of at least one connecting element.

It is thus possible to insert the sleeve bodies into the opening from opposite sides. Thus the collar required for the functioning of the sleeve can be formed on the sleeve, e.g. by throwing, before the sleeve is mounted. The advantage resulting from this feature is that the complex flanging process is no longer necessary for creating the collar and for mounting the sleeve and the sleeve can be mounted on site. Furthermore, sleeves having a large wall thickness and made of high-strength material can be used, since the collar need not be formed by flanging.

The connection between the sleeve bodies can be an interlocked and/or friction-locked and/or adhesively locked connection, e.g. a snap-in connection, a screw connection, a press-fit connection, or an adhesive joint. Furthermore, it is possible to connect the sleeve bodies by friction welding, for example.

It is also advantageous when the connecting element is in the form of a latching element, a threaded connection, or a press connection. This enables the sleeve to be mounted rapidly and manually as compared with the method disclosed in the prior art. Latching elements can be joined easily with the help of pliers, if necessary, and likewise a thread can be joined with a spanner without the use of a stationary tool. Compared with a thread, the advantage of the snap-in connection is that the two sleeve bodies can be press-fitted simultaneously when tightening the screw connection of the component. Large sleeves can also be press-fitted using a hydraulic press or a separate nut-and-bolt connection.

Furthermore it is advantageous when the first sleeve body can be inserted at least partly into the second sleeve body. Such a push-fit connection ensures a defined point of abutment and at the same time a constant outside diameter. The outside diameter of the sleeve may not exceed a defined limit at least in the region in which the sleeve is to be introduced into the opening. The sleeve bodies can be press-fitted or screwed together starting from the point of abutment.

It is also advantageous when the connecting element is located at one end of each sleeve body in the direction of the longitudinal axis, and when means for fixing the sleeve body to the component are formed at that end of s the sleeve body that is remote from the connecting element. Such an arrangement enables the joint between the two sleeve bodies to be disposed within the component or the hollow section, and the sleeve can thus be inserted into the opening of the component or the hollow section from either side.

At least part of said fixing means is advantageously formed by a knurl, which extends around the circumference of the external surface of the sleeve body, and is dimensioned in such a manner that it can engage positively in the component at least over part of the circumference of the sleeve body. Depending on the design of the connecting element between the two sleeve bodies, it is advantageous to secure both sleeve bodies against rotation in the component with the help of the knurl. In the installed state of the sleeve, the knurl penetrates into the wall of the opening.

It is of particular importance for the present invention when at least part of said fixing means is formed by a collar extending around the circumference of the external surface of the sleeve body and when the sleeve body can be caused to bear longitudinally against the component by means of the collar. Said fixing means replace the flanged edge disclosed in the prior art, which axially secures the sleeve to the component. The collar is formed on the sleeve by throwing and the knurl is provided on the sleeve by using a knurling tool before the sleeve is installed.

It is further advantageous when the collar forms a front face of the sleeve body. In most cases, it is necessary for the front face of the sleeve to be precisely flush with the external surface of the component. The collar, which simultaneously forms the front surface of the sleeve, can be shaped., for example, in the form of a countersink such that the front face of the sleeve body is exactly flush with the lateral surface of the component. The collar is countersunk into the opening of the component by mating with a corresponding chamfer on the opening.

Furthermore, it is advantageous when the sleeve body comprises, on its external surface and/or front face, at least one visually conspicuous code mark providing information concerning one or more characteristics of the sleeve body. The code mark can be used for easy identification of, say, the dimensions and the type of material of the sleeve body. The length of the sleeve bodies is of great importance in construction sets, in which sleeves of varying length are used. The sleeve can be made of metal alloys or alternatively of plastics material or a combination of metal and plastics. Tough materials having a high modulus of elasticity, e.g., polyvinyl chloride (PVC), polyamide (PA), polyoxymethylene (POM) and various other polymers and also polyesters can be used as the plastics material. The plastics materials can be fiber-reinforced if necessary.

It is also advantageous when the hollow body has a circular, oval, or rectangular cross-section. The sleeve of the invention can be used, for example, in ladder systems as an alternative for the usually rectangular, flanged rungs.

With regard to the installation of the sleeve, it is advantageous when a centering rod can be inserted into the two sleeve bodies, with the help of which centering rod the two sleeve bodies can be centered in relation to each other. This makes it possible, in the case of very long sleeves, to join the two sleeve bodies rapidly and to ensure a correct fit without the sleeve bodies tilting out of line at the point of abutment. In this respect, it is important to take into consideration that the hollow interior of the component is usually not visible from outside.

Furthermore, it is advantageous for installation of the sleeve when the two sleeve bodies can be connected manually and/or with a manually or pneumatically or hydraulically driven tool. The use of an expensive and complex wobble riveting machine is not necessary.

To facilitate manual connection of the two sleeve bodies, it is advantageous when the sleeve body has slits in the region of the connecting element, which slits extend in the direction of the longitudinal axis. The slits intersect the respective connecting element in the circumferential direction. It is thus possible to effortlessly join the two connecting elements designed as latching elements since the sleeve bodies can spread out more easily in the region of the slits.

An additional possibility, according to a development of the invention, involves forming that connecting element of the first sleeve body that is designed as a latching element as at least one undercut extending in the circumferential direction, and forming that connecting element of the second sleeve body that is designed as a latching element as a snap lug extending in the circumferential direction and adapted to engage the undercut. Such a connection is preferably non-detachable.

Finally, it is advantageous when at least one third sleeve body having two connecting elements is provided, which sleeve body can be inserted as an extension between the first and the second sleeve bodies. It is thus possible to change the length of the sleeve using simple and cheap components, without again having to produce a knurl and collar. This is not detrimental to the stability of the sleeve since the pressure acting on the sleeve acts only in the direction of its longitudinal axis. In a further development, at least the extension parts are made of the aforementioned plastics materials and the two sleeve bodies directly connected to the component are made of metal. The extension is not exposed to any wear and can permanently transfer the required forces in a dimensionally stable manner if it is made of a pressure-resistant plastics material.

A component comprising a sleeve in an opening connecting two sides of the component, particularly a hollow section, comprises a sleeve as described above according to the invention.

### BRIEF DESCRIPTION OF THE DRAWINGS

Additional advantages and details of the invention are described in the claims and description, and are illustrated in the figures, in which:

FIG. 1a is a perspective view of two sleeve bodies prior to introduction thereof into an opening of a component,

FIG. 1b shows the two sleeve bodies shown in FIG. 1a prior to the insertion of a centering rod,

FIG. 1c shows the two sleeve bodies shown in FIG. 1b with the centering rod inserted,

FIG. 1d shows the two sleeve bodies of FIG. 1c locked into position,

FIG. 2a is a side view, with a cut-away portion, of a hollow body comprising two sleeve bodies interconnected by means of a snap-in connection,

FIG. 2b shows the hollow body of FIG. 2a comprising two sleeve bodies interconnected by means of a screw connection,

FIG. 2c shows the hollow body of FIG. 2a comprising two sleeve bodies interconnected by means of an adhesive joint,

FIG. 3a is a perspective view of a hollow body comprising two disconnected sleeve bodies, each of which has a first code mark,

FIG. 3b shows a hollow body similar to that shown in FIG. 3a with a second code mark,

FIG. 3c shows a sleeve body with a third code mark and slits running in the axial direction.

### DESCRIPTION OF EMBODIMENTS OF THE INVENTION

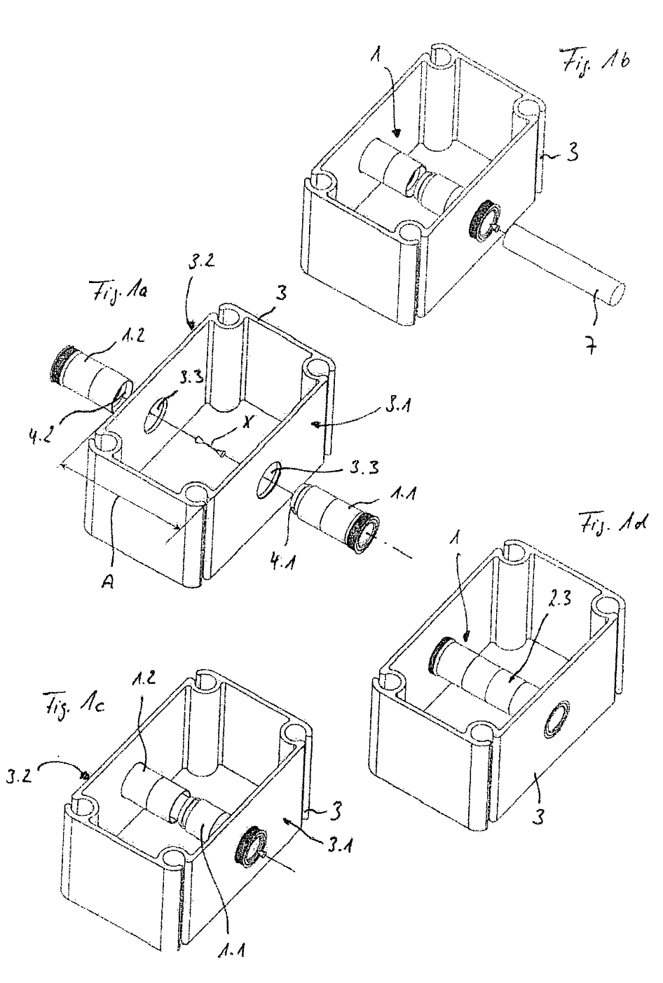

FIGS. 1a to 1d show the assembly sequence of a sleeve comprising a hollow body 1 composed of a first sleeve body 1.1 and a second sleeve body 1.2. The first sleeve body 1.1 is introduced, as shown in FIG. 1a, from a first side 3.1 of a component 3 designed as a hollow section, into an opening 3.3. The opening 3.3 connects the first side 3.1 to a second side 3.2 of the component 3, which second side 3.2 is located opposite the first side 3.1.

The second sleeve body 1.2 is introduced from the second side 3.2 into the opening 3.3.

As shown in FIG. 1b, the two sleeve bodies 1.1, 1.2 are joined with the help of a centering rod 7 without tilting of the sleeve bodies 1.1, 1.2 at the point of abutment. The centering rod 7 is preferably broader than the component 3, so that the two sleeve bodies 1.1, 1.2 can be threaded thereon easily in the case of long sleeves or in mounting areas that are difficult to access. The two sleeve bodies 1.1, 1.2 are interconnected by means of connecting elements 4.1, 4.2 provided at the end of each sleeve body 1.1, 1.2.

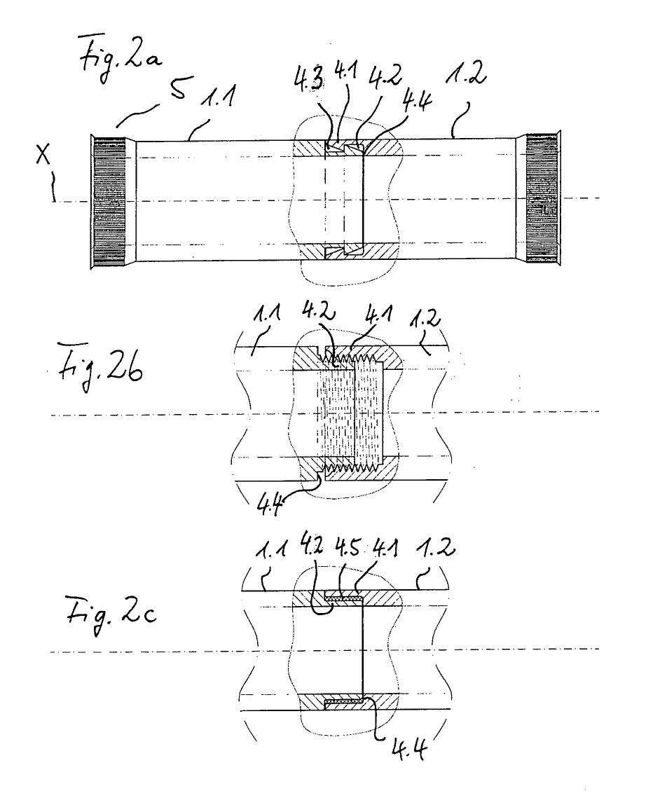

When the two sleeve bodies 1.1, 1.2 are threaded as shown in FIG. 1c, the connecting elements 4.1, 4.2 shown in more detail in FIG. 2a and designed as latching elements, are snapped into a locked position, as shown in FIG. 1d. The connecting elements 4.1, 4.2 lie inside the component 3 between the two sides 3.1, 3.2.

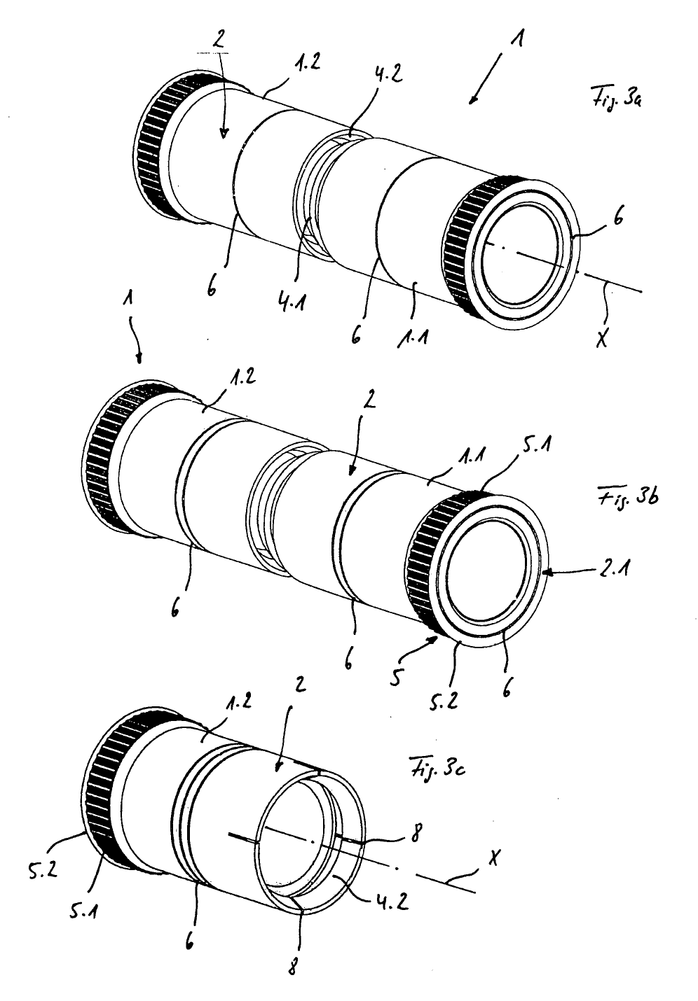

A front face 2.1 shown in FIG. 3b is flush with the respective surface of the two sides 3.1, 3.2 of the hollow section 3 when the sleeve is locked in position. To achieve this end, a collar 5.2, shown in more detail in FIG. 2, comprises a chamfer. This structural advantage cannot be achieved in the press sleeve disclosed in the prior art, since the latter uses a projecting flanged collar.

The component 3 in this exemplary embodiment is a hollow section used for the construction of frames, e.g., tent frames for assembling exhibition stands. Such components are either screwed to each other (not shown) or they are provided with an attachment such as cross-bracing for example.

The bolts for screwing the components to each other are guided through the opening 3.3. It is of great importance to prevent the component 3 from being squeezed when mounting. Furthermore, it is important to prevent the walls of the opening 3.3 from warping with time. This frequently occurs when profiles made of aluminum and thin bolts are used.

When this screw connection is tightened, the sleeve is subjected to pressure, but not the component 3. The sleeve thus prevents the force of the screw connection from being transferred in the direction of a longitudinal axis x directly to the component 3, and the component 3 is thus not squeezed. Furthermore, the sleeve causes the tensile force to be transferred from the bolt to the wall of the opening in the radial direction relatively to the longitudinal axis x via the free-of-play connection between the component 3 and the sleeve bodies 1.1, 1.2.

FIG. 2a shows the hollow body 1 of the sleeve, which hollow body 1 comprises two sleeve bodies 1.1, 1.2. The first sleeve body 1.1 comprises a circumferential snap lug as connecting element 4.1. The snap lug 4.1 engages in that connecting element 4.2 of the second sleeve body 1.2, which is designed as a circumferential undercut. The connecting elements 4.1, 4.2 lock into position when they are pressed together or press-fitted in the direction of the longitudinal axis x over an inclined plane 4.3. The sleeve bodies 1.1, 1.2 then bear against a stop limit surface 4.4 for mutual support. Pressure forces that act on the sleeve when another component is attached by means of a screw connection guided through the sleeve are absorbed by the sleeve itself.

Alternatively, instead of a locking mechanism, a non-positive connection can be produced, for example, by means of a suitable choice of press fits on the sleeve bodies 1.1, 1.2. Here again, the sleeve bodies 1.1, 1.2 can come to bear against a stop limit surface 4.4.

FIG. 2b shows the hollow body of FIG. 2a comprising two sleeve bodies 1.1, 1.2 interconnected by a screw connection comprising an internal thread on the connecting element 4.1 and an external thread on the connecting element 4.2. Here again, the sleeve bodies 1.1, 1.2 come to bear against a stop limit surface 4.4.

FIG. 2c shows the hollow body of FIG. 2a with two sleeve bodies 1.1, 1.2 interconnected by means of an adhesive layer 4.5 comprising an adhesive inner surface on the connecting element 4.1 and an adhesive outer surface on the connecting element 4.2. Here again, the sleeve bodies 1.1, 1.2 come to bear against a stop limit surface 4.4.

The connecting elements 4.1, 4.2 are provided on each of the respective ends of the sleeve bodies 1.1, 1.2. A shaped region 5 is provided on each of those ends of the sleeve bodies 1.1, 1.2 that are located opposite the connecting elements 4.1, 4.2. The shaped region 5 comprises a knurl 5.1 and a collar 5.2. The knurl 5.1 serves to secure the sleeve bodies 1.1, 1.2 in the radial direction in the component 3. The knurl 5.1 avoids the need for a clearance fit between the sleeve body 1.1, 1.2 and the opening 3.3, which clearance fit would require very elaborate means for the production thereof.

The collar 5.2 causes the hollow body 1 to bear against the sides 3.1, 3.2 of the component 3 shown in FIGS. 1a to 1d in the direction of the longitudinal axis x. The hollow body 1 thus does not have any play in the axial direction and absorbs all forces introduced in this direction.

The length L of the press-fitted hollow body 1 is preferably equal to the distance A between the two sides 3.1, 3.2 of the component 3 as shown in FIG. 1a.

FIGS. 3a and 3b show two hollow bodies 1 of different lengths, each comprising two sleeve bodies 1.1, 1.2. The two hollow bodies 1 are characterized by a code mark 6, which provides information concerning the dimensions and the material used, if appropriate. The code mark 6 is applied to an external surface 2 and to the front face 2.1 of the sleeve bodies 1.1, 1.2. The code mark 6 on the external surface 2 facilitates the search for a specific sleeve body 1.1, 1.2 in a construction set. The code mark 6 on the front face 2.1 serves for identification of an already installed sleeve body 1.1, 1.2, the external surface 2 of which is no longer exposed.

FIG. 3c shows the sleeve body 1.2 comprising a plurality of slits 8. The slits 8 intersect the circumferential snap lug and for this purpose extend in the direction of the longitudinal axis x. This simplifies the process of joining or press-fitting the two sleeve bodies 1.1, 1.2.
1 hollow body
1.1 first sleeve member
1.2 second sleeve member
2 external surface
2.1 front face
3 component, hollow section
3.1 first side
3.2 second side
3.3 opening
4.1 coupling element, locking element, undercut
4.2 coupling element, locking element, snap lug
4.3 inclined surface
4.4 stop limit surface
4.5 adhesive layer
5 shaped region
5.1 knurl
5.2 collar
6 code mark
7 centering rod
8 slits
A distance
x longitudinal axis
L length

1. A sleeve for introduction into an opening (3.3) connecting two sides (3.1, 3.2) of a component (3) comprising a hollow body (1) exhibiting a longitudinal axis (x) and an external surface (2), wherein the hollow body (1) can be brought, at least with part of its external surface (2) and at least in the radial direction relatively to the longitudinal axis (x), to bear against the component (3), wherein said hollow body (1) is formed by at least two sleeve members (1.1, 1.2) disposed in-line in the direction of said longitudinal axis (x), the first sleeve member (1.1) and the second sleeve member (1.2) can be interlocked and/or frictionally locked in the axial direction relative to said longitudinal axis (x) via at least one coupling element (4.1, 4.2).

2. The sleeve according to claim 1, wherein that said coupling element (4.1, 4.2) is in the form of a locking element, a thread, an adhesive joint or a force fit connection.

3. The sleeve according to claim 1, wherein said first sleeve member (1.1) can be inserted at least partially into said second sleeve member (1.2).

4. The sleeve according to claim 1, wherein both sleeve members (1.1, 1.2) have a shaped region (5) extending in the direction of said longitudinal axis (x) at one end of said coupling element (4.1, 4.2) and at the end remote from said coupling element (4.1, 4.2), for the purpose of attaching said sleeve member (1.1, 1.2) to said component (3).

5. The sleeve according to claim 4, wherein at least a portion of said shaped region (5) is formed by a knurl (5.1) surrounding said external surface (2) of the sleeve member (1.1, 1.2), said knurl being dimensioned such that it can positively engage the component (3) along at least a portion of the circumference of said sleeve member (1.1, 1.2).

6. The sleeve according to claim 5, wherein at least part of said shaped region (5) is formed by a collar (5.2) surrounding the external surface (2) of the sleeve member (1.1, 1.2) and said sleeve member (1.1, 1.2) can be brought to bear against said component (3) in the direction of the longitudinal axis (x) via said collar (5.2).

7. The sleeve according to claim 6, wherein the collar (5.2) forms a front face (2.1) of the sleeve member (1.1, 1.2).

8. The sleeve according to claim 7, wherein said sleeve member (1.1, 1.2) exhibits at least one visually conspicuous code mark (6) on said external surface (2) and/or on said front face (2.1) providing information on one or more properties of said sleeve member (1.1, 1.2).

9. The sleeve according to claim 8, wherein the hollow body (1) has a round, oval, or rectangular cross-section.

10. The sleeve according to claim 9, wherein a centering rod (7) can be inserted into the two sleeve members (1.1, 1.2), with the aid of which centering rod (7) the two sleeve members (1.1, 1.2) can be centered.

11. The sleeve according to claim 10, wherein the two sleeve members (1.1, 1.2) can be interconnected manually and/or by means of a manually or pneumatically or hydraulically driven tool.

12. The sleeve according to claim 11, wherein said sleeve member (1.1, 1.2) has slits (8) in the region of said coupling element (4.1, 4.2), which slits extend in the direction of the longitudinal axis (x).

13. The sleeve according to claim 12, wherein the coupling element (4.1) of said first sleeve member (1.1) designed as a locking element is in the form of at least one undercut extending in the circumferential direction, and the coupling element (4.2) of said second sleeve member (1.2) designed as a locking element (4.2) is in the form of a snap lug which extends in the circumferential direction and which engages said undercut.

14. The sleeve according to claim 13, wherein at least one third sleeve member having two coupling elements (4.1, 4.2) is provided which can be used as an extension between said first sleeve member (1.1) and said second sleeve member (1.2).

15. A component having a sleeve in an opening connecting the two sides of the component, particularly a hollow section, characterized by a sleeve as defined claim 14.
